(19) United States
(12) Patent Application Publication
(10) Pub. No.: US 2009/0262083 A1
(43) Pub. Date: Oct. 22, 2009

(54) SYSTEMS AND METHODS FOR RECEIVING USER INPUT THROUGH A DISPLAY WITH A FLEXIBLE BACKPLANE VIA TOUCH SENSORS

(76) Inventor: Jateen Parekh, San Francisco, CA (US)

Correspondence Address: AUSTIN RAPP & HARDMAN, 170 South Main Street, Suite 735, SALT LAKE CITY, UT, 84101, US

(21) Appl. No.: 12/104,227

(22) Filed: Apr. 16, 2008

(51) Int. Cl. G06F 3/041

(52) U.S. Cl. 345/173

(57) ABSTRACT

A computing device that is configured to receive input commands via a display is described. The computing device includes a processor and memory in electronic communication with the processor. The device also includes a display. The display includes a flexible backplane. The device further includes a touch sensor. The sensor is positioned underneath the flexible backplane.

### TECHNICAL FIELD

The present disclosure relates generally to electronic devices and computer-related technologies. More specifically, the present disclosure relates to systems and methods for receiving user input through a display with a flexible backplane via touch sensors.

### BACKGROUND

Electronic distribution of information has gained in importance with the proliferation of personal computers and has undergone a tremendous upsurge in popularity as the Internet has become widely available. With the widespread use of the Internet, it has become possible to distribute large, coherent units of information using electronic technologies.

Advances in electronic and computer-related technologies have permitted computers to be packaged into smaller and more powerful electronic devices. An electronic device may be used to receive and process information. The electronic device may provide compact storage of the information as well as ease of access to the information. For example, a single electronic device may store a large quantity of information that might be downloaded instantaneously at any time via the Internet. In addition, the electronic device may be backed up, so that physical damage to the device does not necessarily correspond to a loss of the information stored on the device.

In addition, a user may interact with the electronic device. For example, the user may read information that is displayed by the electronic device. Further, the user may instruct the device to display a specific piece of information stored on the electronic device. As such, benefits may be realized from improved systems and methods for interacting with an electronic device.

### BRIEF DESCRIPTION OF THE DRAWINGS

FIG. 1 is a block diagram illustrating one configuration of a computing device;

FIG. 2 is a block diagram illustrating one example of a flexible display disposed on top of a touch sensitive film;

FIG. 3 is another configuration of a flexible display disposed on top of a touch sensitive film;

FIG. 4 is a block diagram illustrating another configuration of a computing device;

FIG. 5 is a side cross-sectional view of a computing device;

FIG. 6 is a side cross-sectional view of a flexible display;

FIG. 7 illustrates one example of a method for utilizing a flexible display to activate a touch sensitive film disposed underneath the flexible display;

FIG. 8 illustrates various components that may be utilized in a computing device; and

FIG. 9 illustrates various components that may be utilized in an eBook reader/wireless device.

### DETAILED DESCRIPTION

A computing device that is configured to receive input commands via a display is described. The computing device includes a processor and memory in electronic communication with the processor. The device also includes a display. The display includes a flexible backplane. The device further includes a touch sensor. The sensor is positioned underneath the flexible backplane.

In one example, the touch sensor includes a resistive touch sensitive film. The flexible backplane may be made from a plastic material. In one configuration, the display is flexible. The computing device may be an electronic book reader device.

In a further configuration, the display includes a reflective display. The flexible backplane may be an active backplane. In another example, the computing device may include an additional display.

A method for receiving input commands via a display on a device is also described. Power is supplied to the display. The display includes a flexible backplane. Information is displayed via the display. Input is received via a touch sensor. The touch sensor is positioned underneath the display. The input is translated into a command.

A computing device that is configured to receive input commands via a display on a device is also described. The computing device includes means for supplying power to the display. The display includes a flexible backplane. The device also includes means for displaying information via the display and means for receiving input via a touch sensor. The touch sensor is positioned underneath the display. The device further includes means for translating the input into a command.

Current devices may implement a display with a sensor for a touch pad to allow the user to directly interface with the device via the display. A touch sensor may detect the location of touches within the display area. Several different types of technologies have been implemented for touch sensors. One example includes a display with resistive touch sensors. The display with resistive touch sensors may include several layers. Two of these layers may be thin metallic electrically conductive and resistive layers separated by a thin space. When the touch sensors are touched via the display, these two layers connect at a certain point. The sensors may then act similar to two voltage dividers with connected outputs. This may cause a change in the electrical current which is registered as a touch event and sent to a controller for processing. Other types of technologies for touch sensors may include surface acoustic wave technology, pressure sensitivity technology, etc.

Manufacturers of electronic computing devices may provide a touch interface for devices using a display with touch sensors. Computing devices may use a backlight feature to illuminate the information displayed on the display. The backlight feature may include a light source placed behind the display. Devices with backlight features may place a touch sensitive film that utilizes resistive touch screen technology on top of the display.

However, some computing devices may include a reflective display that does not use a backlight feature to illuminate the images and characters on the display. Instead, the images and characters are illuminated by ambient light, light sources external to the device, front lighting, side lighting, etc. A touch sensitive film placed on top of a reflective display may degrade the optical characteristics of images shown on the display. Examples of the optical characteristics may include contrast, color, sharpness, color shifting, etc. As a result, benefits may be realized by placing a touch sensitive film behind a display. Further, benefits may be realized by using a flexible display that includes a flexible backplane.

Several types of display materials may support a flexible backplane. For example an encapsulated material, chemistry or structure that prevents a display image from distortion (until the next refresh of the image) may support a flexible backplane. Encapsulated electrophoretic pigmented, cholesteric chemical and organic light-emitting diode (OLED) display technologies are examples of display materials that may support the flexible backplane.

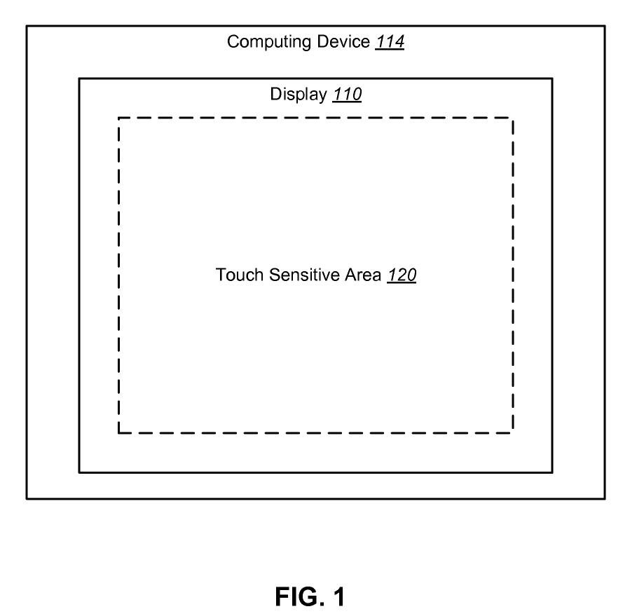

FIG. 1 is a block diagram illustrating one configuration of a computing device 114. The computing device 114 may be a computer, laptop, personal digital assistant (PDA), electronic book (eBook) reader, etc.

The computing device 114 may include a display 110. The display 110 may display images and/or characters to a user of the computing device 114. The display 110 may include a flexible backplane. The backplane may be made of a flexible material. For example, the flexible backplane may be made of plastic, metal (such as stainless steel), glass, etc. In a further configuration, the user may use ambient light (or other light sources exterior to the computing device 114, front lighting, side lighting, etc.) to view the images and/or characteristics on the display 110.

In one example, the display 110 includes a touch sensitive area 120. The touch sensitive area 120 may cover all or a portion of the display 110. The user may provide input commands to the computing device 114 by touching areas of the display 110 within the touch sensitive area 120. For example, the user may apply pressure to the display 110 with a finger, stylus, etc. to provide an input command to the device 114.

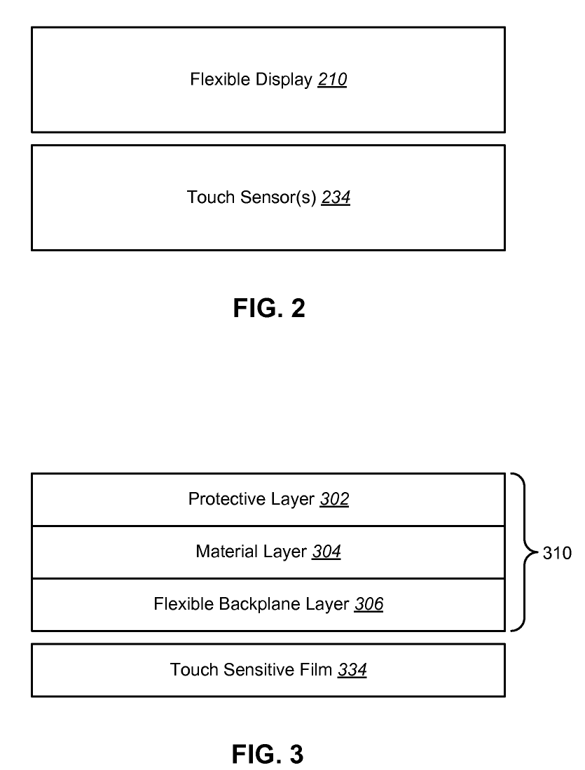

FIG. 2 is a block diagram illustrating one example of a flexible display 210 positioned on top of a touch sensor(s) 234. The touch sensor(s) 234 may be a resistive touch sensitive film. A user may provide input commands to the computing device 114 by touching an area on the flexible display 210. The pressure applied by the user during the touching of the flexible display 210 may cause the display 210 to bend and make contact with an area on the touch sensor(s) 234. The touch sensor(s) 234 may include sensors that detect the area in contact with the flexible display 210. In one example, the sensors may have a resolution of 5-10 millimeters (mm), which is approximately the thickness of a user's finger. The film 234 may interpret the touch as a particular input command provided by the user.

FIG. 3 is another configuration of a flexible display 310 disposed on top of a touch sensitive film 334. The flexible display 310 may include one or more layers. For example, the display 310 may include a protective layer 302 that may be used to provide added protection to the display 310. The protective layer 302 may help to prevent the display 310 from breaking, cracking, being scratched, etc. The protective layer 302 may be made of a flexible material, such as plastic.

The flexible display 310 may also include a material layer 304. The material layer 304 may be made of front planar laminate (FPL). The material layer 304 may include the material composition making up the flexible display 310 (e.g., plastic, glass, etc.) In addition, the flexible display 310 may also include a flexible backplane layer 306. The backplane 306 may be an active backplane or a passive backplane. An active backplane may provide a faster response time and use a low amount of voltage. In one example, an active backplane may be used for video application. A passive backplane may have a slower response time than an active backplane. In addition, the passive backplane may use higher amounts of voltage. In one configuration, a passive backplane may be used for information displays.

The backplane layer 306 may include rows and columns of conductors (not shown) that may be used to activate pixels used to display images and/or characters on the flexible display 310. The backplane 306 may also be made of a flexible material, such as plastic, metal, glass or a polymer based material. A flexible backplane 306 may be bendable, rollable, light-weight, etc. In one configuration, the flexible backplane 306 is a matrix backplane on a plastic substrate.

As illustrated, the touch sensitive film 334 may be disposed underneath (or behind) the flexible display 310. When a user presses on the flexible display 310, it may bend and make contact with the touch sensitive film 334. The contact may activate the film 334 and the film 334 may interpret an input command provided by the user for the computing device 114.

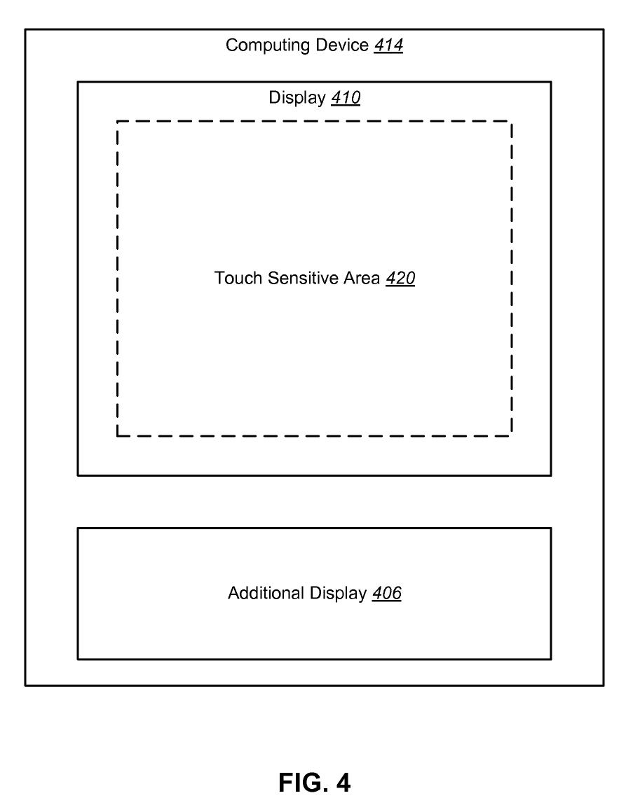

FIG. 4 is a block diagram illustrating another configuration of a computing device 414. The device 414 may include a display 410 and the display 410 may include a touch sensitive area 420. A touch sensitive film (not shown) may be disposed or positioned underneath (or behind) the touch sensitive area 420. As mentioned previously, the touch sensitive area 420 may cover all or a portion of the display 410. In one configuration, the device 414 may include an additional display 406. The additional display 406 may include additional interfaces for a user in addition to the display 410. The additional display 406 may include buttons, switches, etc. The user of the device 414 may interface with the additional display 406 to provide one or more commands to the computing device 414.

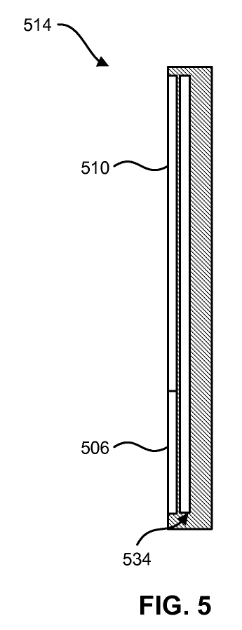

FIG. 5 is a side cross-sectional view of a computing device 514. In one configuration, the computing device 514 is an eBook reader. A touch sensitive film 534 may be disposed directly behind a display 510 and an additional display 506. As previously mentioned, the display 510 may be a flexible display such that it 510 may bend when pressure is applied. The display 510 may bend at the point of pressure and make contact with the touch sensitive film 534. The film 534 may interpret the contact as an input command for the computing device 514. Positioning the touch sensitive film 534 behind the display 510 may provide one or more features or results. Some features that may be provided include reducing the degradation of optical characteristics (e.g., contrast, sharpness, color), providing touch technology on a reflective display, etc.

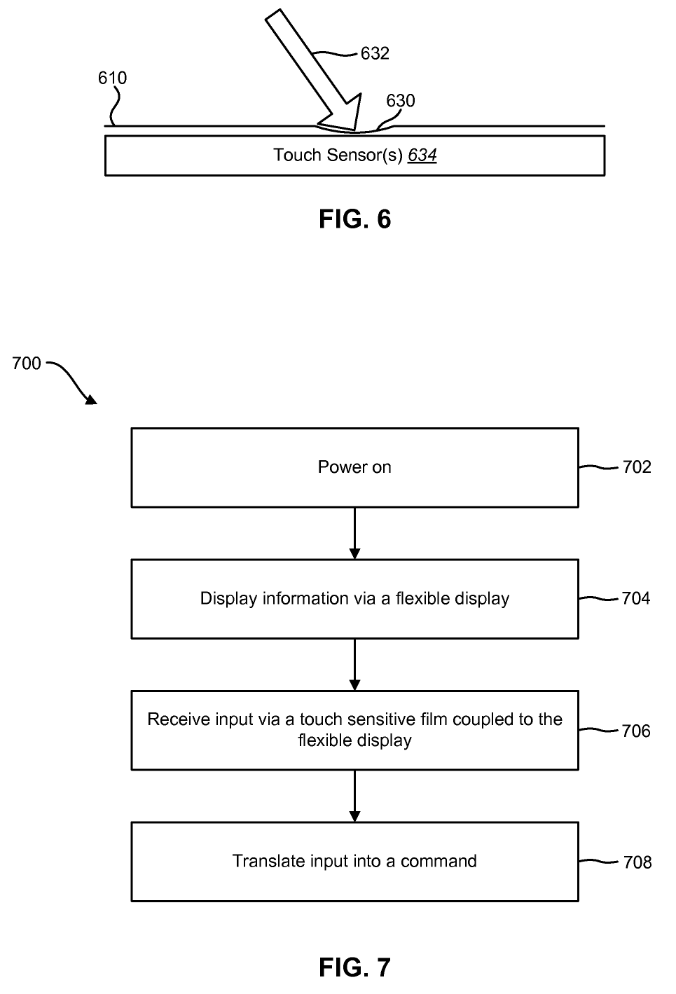

FIG. 6 is a side cross-sectional view of a flexible display 610. A touch sensor(s) 634 may be positioned underneath the display 610. A pointing apparatus 632 or finger may be used to apply pressure to a particular area on the display 610. Because the display is flexible, an indentation 630 may result when the pointing apparatus 632 or finger is pressed down on the display 610. The pointing apparatus 632 may include a finger, stylus, etc. The indentation 630 may provide contact between the display 610 and the touch sensor(s) 634. The contact may activate the sensor(s) 634 and the touch sensor(s) 634 may interpret an input command associated with the contact.

FIG. 7 is a flow diagram illustrating one configuration of a method 700 for activating a touch sensitive film using a flexible display. The flexible display may be disposed on top of the touch sensitive film. In one configuration, a computing device 114 may be powered on 702. The computing device 114 may be an eBook reader, a PDA, a mobile station (such as a cellular telephone), etc. The computing device 114 may include a flexible display 110 and a touch sensitive film 334 disposed underneath the flexible display 110.

In one configuration, information may be displayed 704 by the flexible display 110. The information may include images and characters. In one example, the images and characters may include text of a book, magazine article, etc. In addition, the images and characters may include a list of books, magazines, periodicals, newspapers, etc.

In one example, input may be received 706 from a user via the touch sensitive film 334 that is coupled to the flexible display 110. For example, the user may use a finger to press down on a certain area of the flexible display 110. The certain area may bend and make contact with the touch sensitive film 334 to provide the input. The input may be translated 708 into a command. In one configuration, the touch sensitive film 334 translates the input into a command for the computing device.

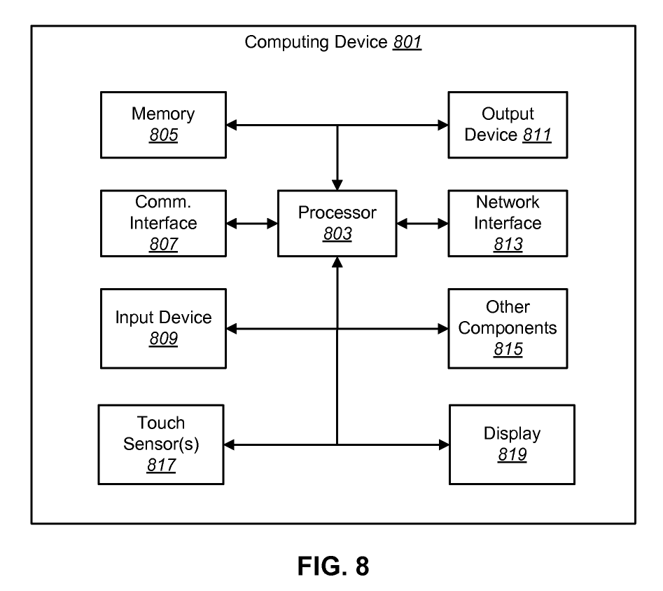

FIG. 8 illustrates various components that may be utilized in a computing device 801. One or more computing devices 801 may be used to implement the various systems and methods disclosed herein. The illustrated components may be located within the same physical structure or in separate housings or structures. Thus, the term computing device 801 is used to mean one or more broadly defined computing devices unless it is expressly stated otherwise. Computing devices include the broad range of digital computers including microcontrollers, hand-held computers, personal computers, servers, mainframes, supercomputers, minicomputers, workstations, and any variation or related device thereof.

The computing device 801 is shown with a processor 803 and memory 805. The processor 803 may control the operation of the computing device 801 and may be embodied as a microprocessor, a microcontroller, a digital signal processor (DSP) or other device known in the art. The processor 803 typically performs logical and arithmetic operations based on program instructions stored within the memory 805. The instructions in the memory 805 may be executable to implement the methods described herein.

The computing device 801 may also include one or more communication interfaces 807 and/or network interfaces 813 for communicating with other electronic devices. The communication interface(s) 807 and the network interface(s) 813 may be based on wired communication technology, wireless communication technology, or both.

The computing device 801 may also include one or more input devices 809 and one or more output devices 811. The input devices 809 and output devices 811 may facilitate user input. In addition, the computing device 801 may include a touch sensor(s) 817 and a display 819. The display 819 may be a flexible display. The touch sensor(s) 817 may detect input commands upon activation. The sensor(s) 817 may be activated by touch. Other components 815 may also be provided as part of the computing device 801.

FIG. 8 illustrates only one possible configuration of a computing device 801. Various other architectures and components may be utilized.

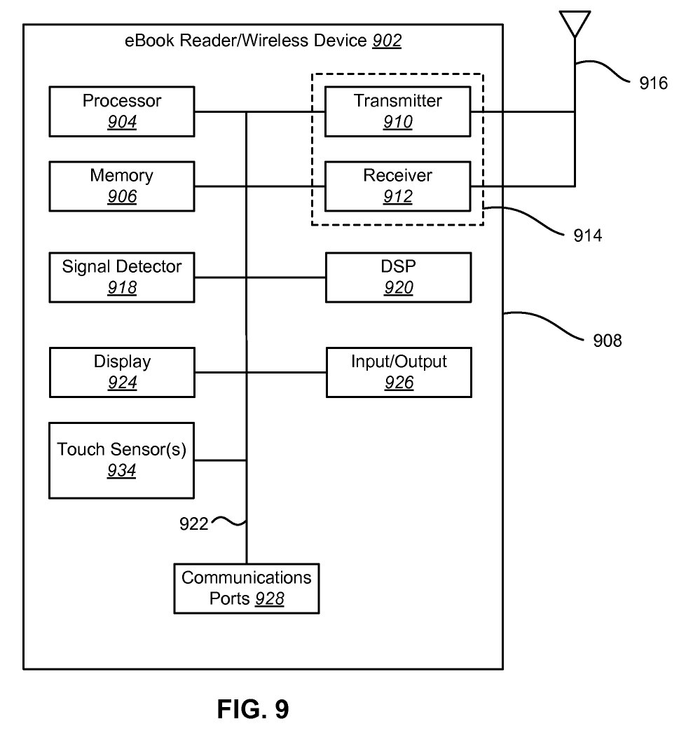

FIG. 9 illustrates various components that may be utilized in an eBook reader/wireless device 902. Electronic books (“eBooks”) are digital works. The terms “eBook” and “digital work” are used synonymously and, as used herein, may include any type of content which can be stored and distributed in digital form. By way of illustration, without limitation, digital works and eBooks can include all forms of textual information such as books, magazines, newspapers, newsletters, periodicals, journals, reference materials, telephone books, textbooks, anthologies, proceedings of meetings, forms, directories, maps, manuals, guides, references, photographs, articles, reports, documents, etc., and all forms of audio and audiovisual works such as music, multimedia presentations, audio books, movies, etc.

The device 902 is an example of a device that may be configured to implement and/or be used with the various methods described herein, such as the computing device 114. Examples of devices 902 include, but are not limited to, cell phones, laptop computers, personal digital assistants (PDA), tablet computers and eBook reader devices.

The wireless device 902 may include a processor 904 which controls operation of the wireless device 902. The processor 904 may also be referred to as a central processing unit (CPU). Memory 906, which may include both read-only memory (ROM) and random access memory (RAM), provides instructions and data to the processor 904. A portion of the memory 906 may also include non-volatile random access memory (NVRAM). The processor 904 typically performs logical and arithmetic operations based on program instructions stored within the memory 906. The instructions in the memory 906 may be executable to implement the methods described herein.

The wireless device 902 may also include a housing 908 that may include a transmitter 910 and a receiver 912 to allow transmission and reception of data between the wireless device 902 and a remote location. The transmitter 910 and receiver 912 may be combined into a transceiver 914. An antenna 916 may be attached to the housing 908 and electrically coupled to the transceiver 914. The wireless device 902 may also include (not shown) multiple transmitters, multiple receivers, multiple transceivers and/or multiple antenna.

The wireless device 902 may also include a signal detector 918 that may be used to detect and quantify the level of signals received by the transceiver 914. The signal detector 918 may detect such signals as total energy, pilot energy per pseudonoise (PN) chips, power spectral density, and other signals. The wireless device 902 may also include a digital signal processor (DSP) 920 for use in processing signals.

The wireless device 902 may also include one or more communication ports 928. Such communication ports 928 may allow direct wired connections to be easily made with the device 902.

Additionally, input/output components 926 may be included with the device 902 for various input and output to and from the device 902. Examples of different kinds of input components include a keyboard, keypad, mouse, microphone, remote control device, buttons, joystick, trackball, touchpad, lightpen, etc. Examples of different kinds of output components include a speaker, printer, etc. One specific type of output component is a display 924. The display 924 may be a flexible display as described herein. In addition, the device 902 may include a touch sensor(s) 934. The touch sensor(s) 934 may detect input commands upon activation. The sensor(s) 934 may be activated by touch.

The various components of the wireless device 902 may be coupled together by a bus system 922 which may include a power bus, a control signal bus, and a status signal bus in addition to a data bus. However, for the sake of clarity, the various busses are illustrated in FIG. 9 as the bus system 922.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A computing device that is configured to receive input commands via a: display, the computing device comprising:
a processor;
memory in electronic communication with the processor;
a display, wherein the display includes a flexible backplane; and
a touch sensor, wherein the sensor is positioned underneath the flexible backplane.

2. The computing device of claim 1, wherein the touch sensor comprises a resistive touch sensitive film.

3. The computing device of claim 1, wherein the flexible backplane is made from a plastic material.

4. The computing device of claim 1, wherein the display is flexible.

5. The computing device of claim 1, wherein the computing device is an electronic book reader device.

6. The computing device of claim 1, wherein the display comprises a reflective display.

7. The computing device of claim 1, wherein the flexible backplane is an active backplane.

8. The computing device of claim 1, further comprising an additional display.

9. A method for receiving input commands via a display on a device, comprising:
supplying power to the display, wherein the display comprises a flexible backplane;
displaying information via the display;
receiving input via a touch sensor, wherein the touch sensor is positioned underneath the display; and
translating the input into a command.

10. The method of claim 9, further comprising receiving input via a resistive touch sensitive film.

11. The method of claim 9, wherein the flexible backplane is made from a plastic material.

12. The method of claim 9, wherein the display comprises a flexible display.

13. The method of claim 9, wherein the method is implemented by an electronic book reader.

14. The method of claim 9, wherein the display comprises a reflective display.

15. The method of claim 9, wherein the flexible backplane is an active backplane.

16. A computer program for performing the method of claim 9.

17. A computing device that is configured to receive input commands via a display on a device, the computing device comprising:
means for supplying power to the display, wherein the display comprises a flexible backplane;
means for displaying information via the display;
means for receiving input via a touch sensor, wherein the touch sensor is positioned underneath the display; and
means for translating the input into a command.
